(19) United States
(12) Patent Application Publication
(10) Pub. No.: US 2018/0246492 A1
(43) Pub. Date: Aug. 30, 2018

(54) Numerical Control Device

(71) Applicant: DMG Mori Co., LTD., Nara (JP)

(72) Inventors: Yutaka Ido, Nara (JP); Masahiro Shimoike, Nara (JP)

(73) Assignee: DMG Mori Co., LTD., Nara (JP)

(21) Appl. No.: 15/753,850

(22) PCT Filed: May 24, 2016
(86) PCT No.: PCT/JP2016/065247

§ 371 Date: Feb. 20, 2018

(30) Foreign Application Priority Data
Sep. 11, 2015 (JP) 2015-179196

(51) Int. Cl. G05B 19/402; B23Q 15/24

(52) U.S. Cl. CPC G05B 19/402; B23Q 15/24; G05B 2219/36492; B23Q 2717/00; B23Q 2716/00; B23Q 2220/006

(57) ABSTRACT

Provided is a numerical control device capable of positioning a tool tip position in three-dimensional space with high accuracy. A numerical control device (1) includes a position compensator (5) and an error data storage (10). The error data storage (10) stores therein error data relating to angular errors (Eax, Eay, Eaz) around an X-axis, angular errors (Ebx, Eby, Ebz) around a Y-axis, and angular errors (Ecx, Ecy, Ecz) around a Z-axis in the X-, Y-, and Z-axes. The position compensator (5) calculates, based on commanded positions (Ix, Iy, Iz), the error data, and tool length data for a tool to be used, modification amounts (Mx, My, Mz) that vary in accordance with the tool length, modifies compensation amounts (Cx, Cy, Cz) for the commanded positions (Ix, Iy, Iz), and compensates for the commanded positions (Ix, Iy, Iz) with the modified compensation amounts.

### TECHNICAL FIELD

The present invention relates to a numerical control device for, in a machine tool including feed axes for a Z-axis that extends along an axis of a spindle, and an X-axis and a Y-axis that are orthogonal to the Z-axis and orthogonal to each other, numerically controlling the feed axes.

### BACKGROUND ART

Conventionally, positioning errors in the feed axes for the X-axis, Y-axis, and Z-axis, straightness of the feed axes, and an orientational error in three-dimensional space of the spindle are considered as motion error factors for the machine tool, and in order to compensate for such motion errors, a numerical control device as disclosed in Japanese Unexamined Patent Application Publication No. H8-152909 (Patent Literature 1 listed below) has been proposed.

This numerical control device, as disclosed in Patent Literature 1, includes grid-point-compensation-vector storing means that stores therein grid-point compensation vectors which are previously measured at grid points of a grid area resulted from dividing a coordinate system with a certain interval in each coordinate-axis direction, interpolating means that outputs an interpolation pulse for each feed axis in accordance with a movement command, current-position recognizing means that recognizes a current position in each feed axis by adding the interpolation pulse, current-position-compensation-vector calculating means that calculates a current-position compensation vector at the current position based on the grid-point compensation vectors, compensation-pulse outputting means that compares the current-position compensation vector with a start-point compensation vector for a previous current position prior to interpolation and outputs an amount of change as a compensation pulse, and adding means that adds the compensation pulse to the interpolation pulse.

In this numerical control device, each time the interpolation pulse is output, a three-dimensional compensation vector at the current position is calculated and the calculated three-dimensional compensation vector is added as a compensation pulse to the interpolation pulse. Therefore, a positional error in a three-dimensional space that is caused by a mechanical system can be compensated for by a single interpolation-type error compensation function.

Note that the grid-point compensation vector at each grid point of the grid area is obtained by measuring a positioning error in three-dimensional space of a reference position in controlling positioning of the feed axes with a certain interval, the reference position being set on the axis of the spindle as appropriate. Further, the measurement is typically carried out with a laser interferometer, a laser length measuring device, an auto-collimator, or the like. Furthermore, the reference position is typically set at, for example, a position at which the axis of the spindle intersects with a front end surface of the spindle or a position which is located forward of the front end surface of the spindle by a predetermined distance on the axis of the spindle, the reference position being determined as appropriate depending on the measurement method.

By the way, a commanded position commanded in a machining program is usually intended for a machining point, that is, a tool tip position on the axis of the spindle. Therefore, in positioning control by a numerical control device, it is necessary to compensate for a difference (variation) in tool tip position in accordance with a length of a tool to be used. Conventionally, in order to achieve such compensation, it has been usual that a length from the reference position to a tool tip is designated as a tool offset amount, a tool offset amount is previously set for each tool, and, in accordance with a tool to be used, the commanded position is offset by the tool offset amount for the tool in the Z-axis direction that extends along a longitudinal extent of the tool.

For example, as shown in FIG. 10, when viewed in a plane defined by the X-axis and the Z-axis, where the length from the reference position R to the tool tip Tt, that is, the tool offset amount is represented by L, a commanded position P₁ (x₁, z₁) in a machining program is offset by the tool offset amount L in the plus Z-axis direction that extends along a longitudinal extent of the tool, thereby resulting in a position P₁′ (x₁′, z₁′).

x₁′=x₁

z₁′=z₁+L

Note that, for the purpose of easy explanation, FIG. 10 shows a relationship in a two-dimensional plane defined by the X-axis and the Z-axis. In this connection, in this two-dimensional plane, motion errors are measured with respect to the reference position R. Accordingly, if the reference position R is located at the position P₁″ (x₁″, z₁″) with respect to the offset position P₁′ (x₁′, z₁′) in this plane defined by the X-axis and the Z-axis, compensation values Cx₁, Cz₁ for compensating for positioning errors are calculated as follows:

Cx₁=x₁′−x₁″=x₁−x₁″; and

Cz₁=z₁′−z₁″=z₁+L−z₁″.

### CITATION LIST

### Patent Literature

Patent Literature 1: Japanese Unexamined Patent Application Publication No. H8-152909

### SUMMARY OF INVENTION

### Technical Problem

However, although the above-described conventional numerical control device is capable of compensating for errors such as positioning errors in the feed axes, straightness of the feed axes, and an orientational error in three-dimensional space of the spindle, it still depends only on tool offset in the Z-axis direction based on tool length for compensation of positioning errors caused by tool length. Therefore, in this respect, this numerical control device has a problem that it cannot carry out an accurate positioning.

Similarly to FIG. 10, FIG. 11 shows a relationship in a two-dimensional plane defined by the X-axis and the Z-axis, for the purpose of easy explanation. As shown in FIG. 11, if there is an error in the orientation of the spindle S and the spindle S is therefore tilted by an angle θ with respect to the Z-axis, the tool tip position Tt is displaced by L·sin θ in the X-axis direction and by L·(1−cos θ) in the Z-axis direction from the position thereof shown in FIG. 10.

Therefore, an accurate positioning of the tool tip Tt is not achieved without compensating for these displacement amounts. In other words, in order to achieve a highly accurate positioning of the tool tip Tt, it is necessary to compensate for such errors caused by tool length. However, the above-described conventional numerical control device is not capable of compensating for such positioning errors caused by tool length.

The present invention has been achieved in view of the above-described circumstances, and an object thereof is to provide a numerical control device which is capable of positioning a tip position of a tool attached to a spindle in a three-dimensional space with higher accuracy.

### Solution to Problem

The present invention, for solving the above-described problem, relates to a numerical control device for, in a machine tool including a spindle holding a tool, and feed axes corresponding to reference axes: a Z-axis extending along an axis of the spindle, and an X-axis and a Y-axis orthogonal to the Z-axis and orthogonal to each other, numerically controlling the feed axes,

the numerical control device including:

an error data storage storing therein error data including components regarding angular errors Eax, Eay, Eaz around the X-axis in the feed axes, angular errors Ebx, Eby, Ebz around the Y-axis in the feed axes, and angular errors Ecx, Ecy, Ecz around the Z-axis in the feed axes; and

a position compensator compensating for commanded positions Ix, Iy, Iz for the feed axes with compensation amounts Cx, Cy, Cz corresponding to the commanded positions Ix, Iy, Iz,

the position compensator being further configured to calculate, based on the commanded positions Ix, Iy, Iz for the feed axes, the error data stored in the error data storage, and data on a tool length of a tool to be used for machining, modification amounts Mx, My, Mz for the compensation amounts Cx, Cy, Cz for the feed axes in accordance with equations below and modify the compensation amounts Cx, Cy, Cz with the calculated modification amounts Mx, My, Mz, the modification amounts Mx, My, Mz varying in accordance with the tool length:

Mx=−(Ecx+Ecy+Ecz)−Ly+(Ebx+Eby+Ebz)−Lz;

My=−(Eax+Eay+Eaz)−Lz+(Ecx+Ecy+Ecz)−Lx; and

Mz=−(Ebx+Eby+Ebz)−Lx+(Eax+Eay+Eaz)−Ly.

In the equations, Lx, Ly, and Lz are deviations from a predetermined reference position of a tip position of a tool attached to the spindle of the machine tool, Lx being a deviation in the X-axis direction, Ly being a deviation in the Y-axis direction, and Lz being a deviation in the Z-axis direction.

Note that, in each of the equations for calculating Mx, My, Mz, whether the first term is positive or negative and whether the second term is positive or negative are each determined in accordance with the positive/negative directions of the X-axis, Y-axis, and Z-axis.

In the numerical control device according to the present invention, the position compensator compensates for commanded positions Ix, Iy, Iz for the X-axis, Y-axis, and Z-axis with compensation amounts (compensation amounts for compensating for motion errors in three-dimensional space of the machine tool) Cx, Cy, Cz corresponding to the commanded positions Ix, Iy, Iz. Such compensation compensates for motion errors in three-dimensional space of the machine tool with high accuracy.

Further, the position compensator calculates, based on the commanded positions Ix, Iy, Iz for the feed axes, the error data stored in the error data storage, and data on a tool length of a tool to be used for machining, modification amounts Mx, My, Mz, which vary in accordance with the tool length, for the compensation amounts Cx, Cy, Cz for the feed axes, and modifies the compensation amounts Cx, Cy, Cz with the calculated modification amounts Mx, My, Mz. Note that the modification amounts Mx, My, Mz compensate for a positional error of a tool tip which is caused by an orientational error in three-dimensional space of the spindle and which occurs in accordance with the tool length.

Thus, the numerical control device according to the present invention is capable of compensating for motion errors in three-dimensional space of the machine tool and compensating for a positional error of a tool tip which occurs in accordance with an orientational error of the spindle and the tool length; therefore, the numerical control device is capable of controlling positioning of a tool tip position in three-dimensional space with higher accuracy than the conventional art.

The numerical control device according to the present invention may further include a tool length data storage storing therein data varying in accordance with the tool length of the tool to be used for machining, and the position compensator may be configured to calculate the modification amounts Mx, My, Mz based on the data stored in the tool length data storage.

Further, the tool length data storage may be configured to store therein a tool offset amount for offsetting the commanded positions Ix, Iy, Iz in accordance with the tool length.

### Advantageous Effects of Invention

As described above, the present invention is capable of compensating for motion errors in three-dimensional space of a machine tool and compensating for a positional error of a tool tip which occurs in accordance with an orientational error of a spindle and the tool length; therefore, the present invention is able to control positioning of a tool tip position in three-dimensional space with higher accuracy than the conventional art.

### BRIEF DESCRIPTION OF DRAWINGS

FIG. 1 is a block diagram showing a schematic configuration of a numerical control device according to an embodiment of the present invention;

FIG. 2 is an illustration for explaining a machine tool and measurement of motion errors thereof;

FIG. 3 shows graphs showing measured motion errors;

FIG. 4 shows graphs showing measured motion errors;

FIG. 5 shows graphs showing measured motion errors;

FIG. 6 is an illustration showing motion errors at grid points of a motion area of the machine tool divided in a grid-like pattern;

FIG. 7 is an illustration showing motion errors at grid points of the motion area of the machine tool divided in the grid-like pattern;

FIG. 8 is an illustration showing motion errors at grid points of the motion area of the machine tool divided in the grid-like pattern;

FIG. 9 is an illustration for explaining calculation of compensation amounts for motion errors;

FIG. 10 is an illustration for explaining a conventional problem; and

FIG. 11 is an illustration for explaining the conventional problem.

### DESCRIPTION OF EMBODIMENTS

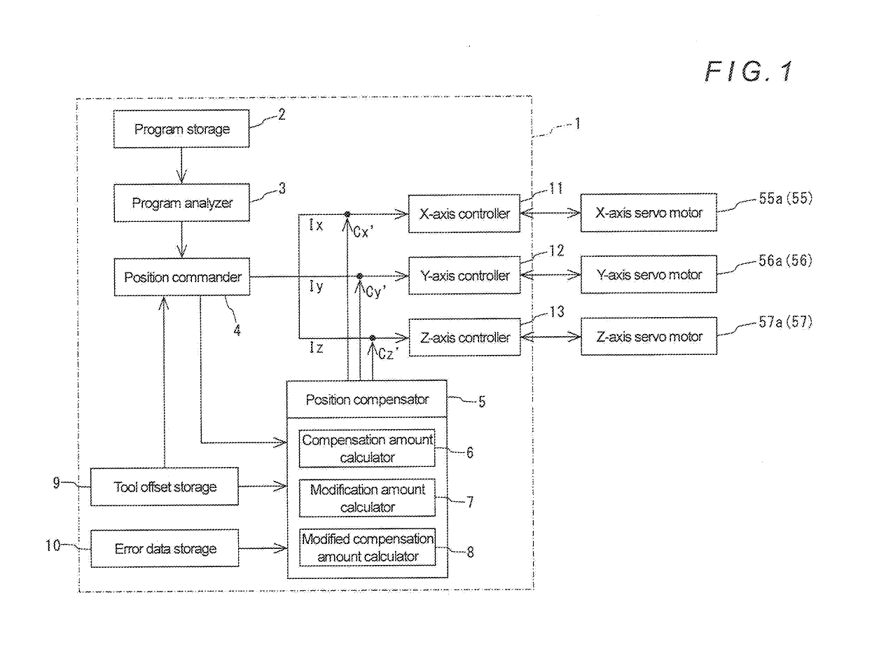

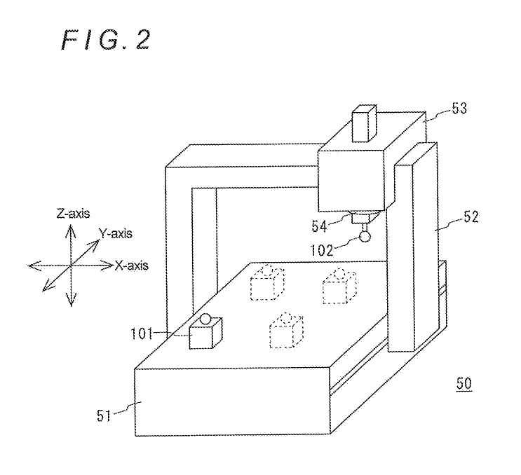

Hereinafter, a specific embodiment of the present invention will be described with reference to the drawings. FIG. 1 shows a schematic configuration of a numerical control device according to the embodiment of the present invention, and FIG. 2 shows an example of a machine tool to be controlled by the numerical control device.

As shown in FIG. 2, the machine tool 50 in this embodiment is composed of a bed 51 having a workpiece placement surface (so-called table) on a top surface thereof, a portal frame 52, and a saddle 53. The frame 52 is disposed such that a horizontal portion thereof is positioned above the bed 51, and two vertical portions thereof are engaged with side portions of the bed 51 to allow the frame 52 to move as a whole in a direction of a Y-axis. The saddle 53 is engaged with the horizontal portion of the frame 52 and is configured to be movable in a direction of an X-axis along the horizontal portion of the frame 52. Further, a spindle 54 is held by the saddle 53 in a manner to be movable in a direction of a Z-axis and rotatable about an axis parallel to the Z-axis.

The X-axis, the Y-axis, and the Z-axis are reference axes that are orthogonal to one another, and feed axes corresponding to the reference axes are respectively composed of an X-axis feed mechanism 55, a Y-axis feed mechanism 56, and a Z-axis feed mechanism 57, which are shown in FIG. 1. Note that the X-axis feed mechanism 55 includes a ball screw (not shown), a ball nut (not shown), and an X-axis servo motor 55a driving the ball screw (not shown), and moves the saddle 53 in the X-axis direction.

The Y-axis feed mechanism 56 similarly includes a ball screw (not shown), a ball nut (not shown), and a Y-axis servo motor 56a driving the ball screw (not shown), and moves the frame 52 in the Y-axis direction.

Further, the Z-axis feed mechanism 57 also similarly includes a ball screw (not shown), a ball nut (not shown), and a Z-axis servo motor 57a driving the ball screw (not shown), and moves the spindle 54 in the Z-axis direction.

As shown in FIG. 1, the numerical control device 1 according to this embodiment is configured to include the following functional units: a program storage 2, a program analyzer 3, a position commander 4, a position compensator 5, a tool offset storage 9, an error data storage 10, an X-axis controller 11, a Y-axis controller 12, and a Z-axis controller 13.

The program storage 2 is a functional unit that stores therein machining programs for carrying out machining with the machine tool 50. Note that the machining programs contain commands relating to moving positions and feed speeds for the feed axes, i.e., the X-axis feed mechanism 55, the Y-axis feed mechanism 56, and the Z-axis feed mechanism 57, commands relating to rotation of the spindle 54, a tool number of a tool to be used, etc.

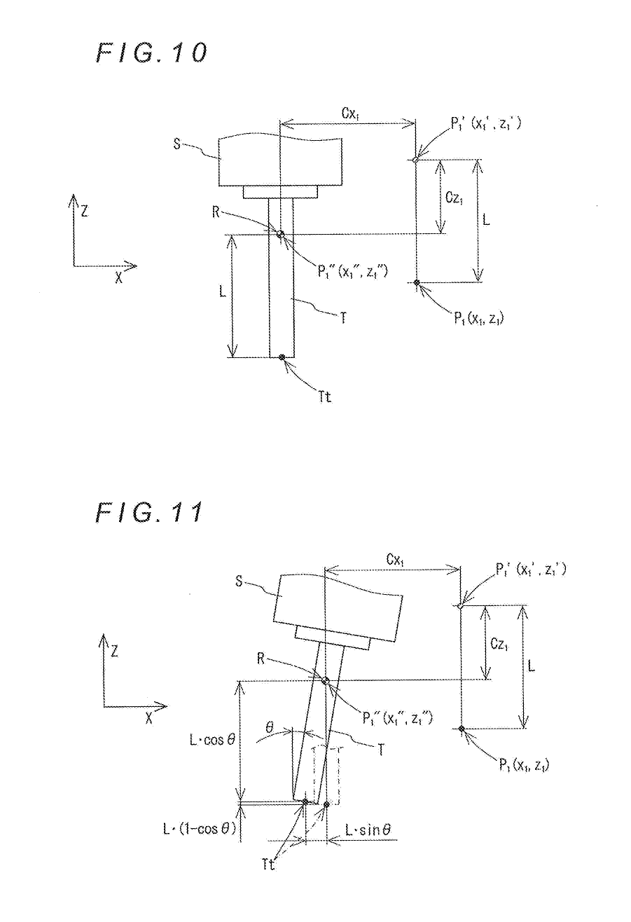

The tool offset storage 9 is a functional unit that stores therein offset amounts for a plurality of tools to be used for machining, the offset amount for each tool being determined based on a tool length thereof. Note that, specifically, as shown in FIG. 10, the tool offset amount in this embodiment is defined as a distance L from a reference position R set on an axis of a spindle S (corresponding to the spindle 54 in this embodiment) to a tip Tt of a tool T. Further, although not specifically shown in FIG. 2, the machine tool 50 has attached thereto a tool magazine and a tool changer, the tool magazine storing a plurality of tools therein, and the tool changer attaching a tool stored in the tool magazine to the spindle 54. When any one of the machining programs is executed, a tool commanded in the machining program is attached to the spindle 54 by the tool changer.

The error data storage 10 is a functional unit that stores therein error data relating to positioning errors Exx, Eyy, Ezz in the X-axis, Y-axis, and Z-axis directions in the X-axis feed mechanism 55, Y-axis feed mechanism 56, and Z-axis feed mechanism 57, straightness errors Eyx, Ezx, Exy, Ezy, Exz, Eyz in the X-axis feed mechanism 55, Y-axis feed mechanism 56, and Z-axis feed mechanism 57, angular errors Eax, Eay, Eaz around the X-axis in the X-axis feed mechanism 55, Y-axis feed mechanism 56, and Z-axis feed mechanism 57, angular errors Ebx, Eby, Ebz around the Y-axis in the X-axis feed mechanism 55, Y-axis feed mechanism 56, and Z-axis feed mechanism 57, and angular errors Ecx, Ecy, Ecz around the Z-axis in the X-axis feed mechanism 55, Y-axis feed mechanism 56, and Z-axis feed mechanism 57.

More specifically, the above-mentioned errors are defined as follows:

Exx: a positioning error in the X-axis direction in the X-axis feed mechanism 55;
Eyy: a positioning error in the Y-axis direction in the Y-axis feed mechanism 56;
Ezz: a positioning error in the Z-axis direction in the Z-axis feed mechanism 57;
Eyx: a straightness error in a plane defined by the X-axis and the Y-axis in the X-axis feed mechanism 55;
Ezx: a straightness error in a plane defined by the X-axis and the Z-axis in the X-axis feed mechanism 55;
Exy: a straightness error in a plane defined by the Y-axis and the X-axis in the Y-axis feed mechanism 56;
Ezy: a straightness error in a plane defined by the Y-axis and the Z-axis in the Y-axis feed mechanism 56;
Exz: a straightness error in a plane defined by the Z-axis and the X-axis in the Z-axis feed mechanism 57;
Eyz: a straightness error in a plane defined by the Z-axis and the Y-axis in the Z-axis feed mechanism 57;
Eax: an angular error around the X-axis in the X-axis feed mechanism 55;
Eay: an angular error around the X-axis in the Y-axis feed mechanism 56;
Eaz: an angular error around the X-axis in the Z-axis feed mechanism 57;
Ebx: an angular error around the Y-axis in the X-axis feed mechanism 55;
Eby: an angular error around the Y-axis in the Y-axis feed mechanism 56;
Ebz: an angular error around the Y-axis in the Z-axis feed mechanism 57;
Ecx: an angular error around the Z-axis in the X-axis feed mechanism 55;
Ecy: an angular error around the Z-axis in the Y-axis feed mechanism 56; and
Ecz: an angular error around the Z-axis in the Z-axis feed mechanism 57.

For example, the above errors can be obtained from results of measurement using a laser length measuring device 101 as shown in FIG. 2. Specifically, in a state where the laser length measuring device 101 is disposed on the bed 51 and a mirror 102 is attached to the spindle 54, positioning of each of the X-axis feed mechanism 55, Y-axis feed mechanism 56, and Z-axis feed mechanism 57 is controlled with a certain interval so as to position the mirror 102 at each grid point of a three-dimensional space that is divided in a grid-like pattern with the certain interval, and at each grid point, a laser beam is irradiated from the laser length measuring device 101 to the mirror 102 and a reflected light of the laser beam is received by the laser length measuring device 101, whereby the distance between the laser length measuring device 101 and the mirror 102 is measured by the laser length measuring device 101.

Subsequently, the laser length measuring device 101 is arranged at two or more other different locations (for example, the locations indicated by broken lines in FIG. 2) and the mirror 102 is arranged at a position different from the position thereof in the above measurement with respect to the laser length measuring device 101 at at least one of the different locations, in which state, similarly to the above measurement, the mirror 102 is positioned at each grid point of the three-dimensional space and the distance between the laser length measuring device 101 and the mirror 102 is measured by the laser length measuring device 101 at each grid point.

The position of the mirror 102 at each grid point of the three-dimensional space is calculated in accordance with the principle of triangulation based on the measurement data obtained in the above-described manner, and, based on the calculated position data and analysis of the position data, the above-mentioned errors are obtained. Note that one of the positions of the mirror 102 is a reference position (corresponding to the reference position R shown in FIGS. 10 and 11) set on the axis of the spindle 54.

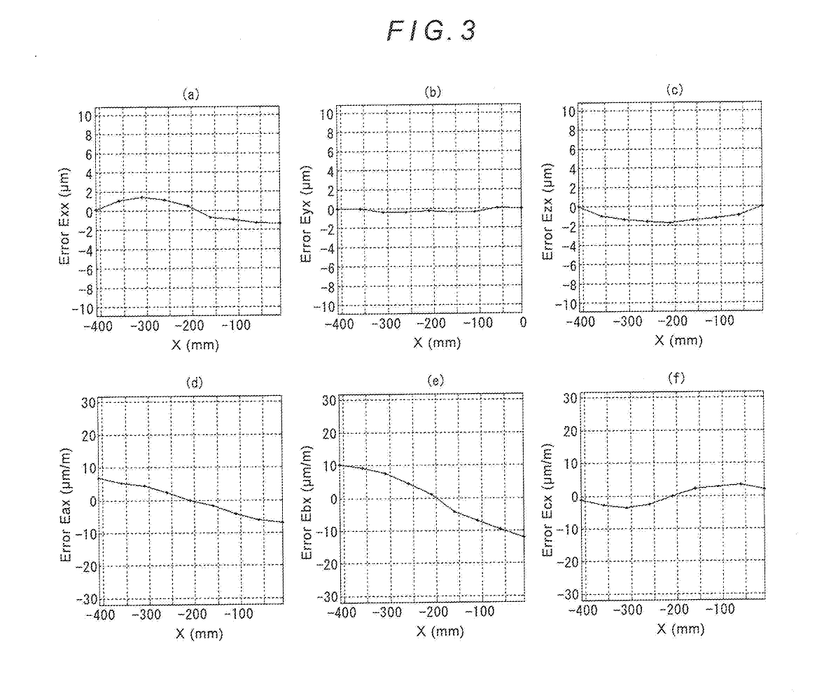

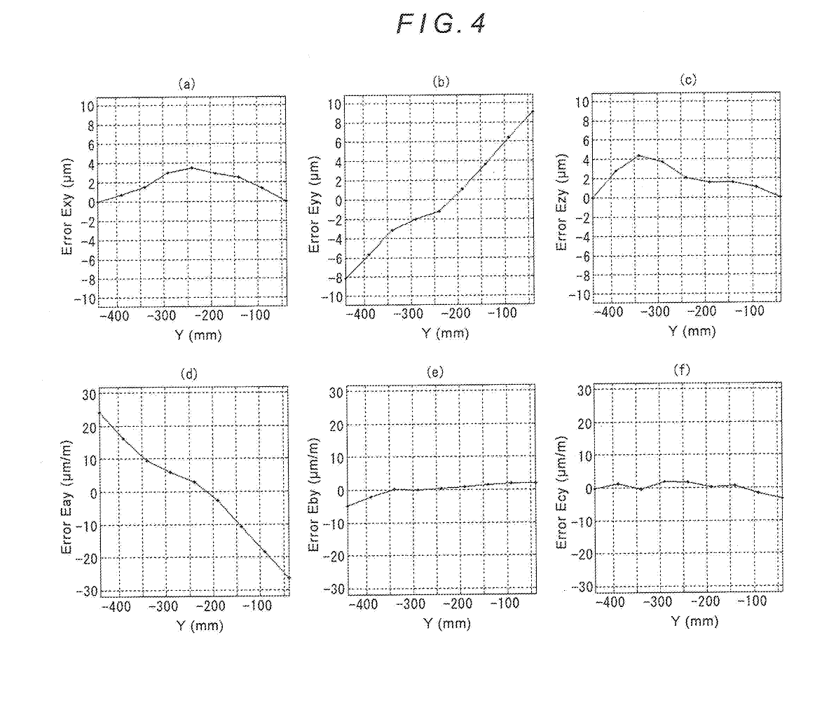

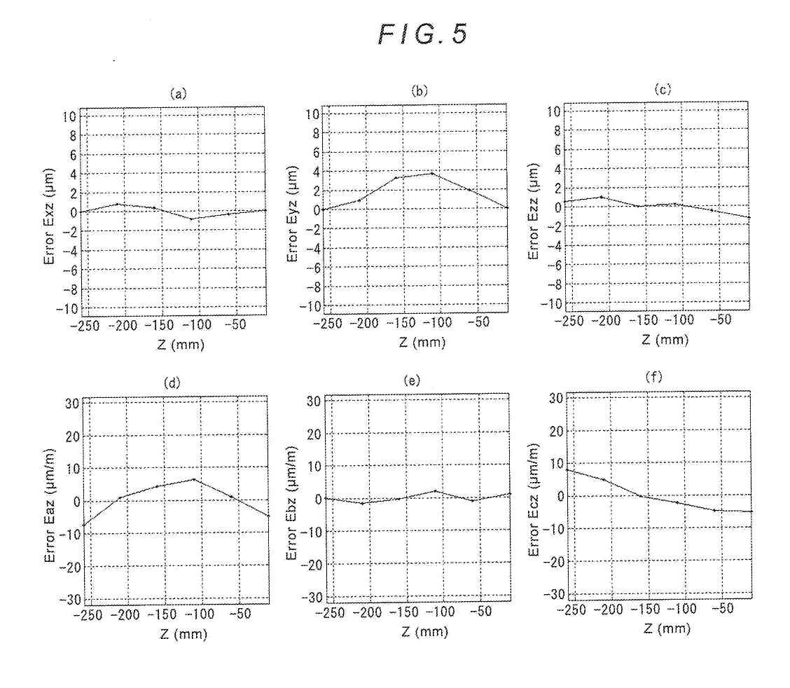

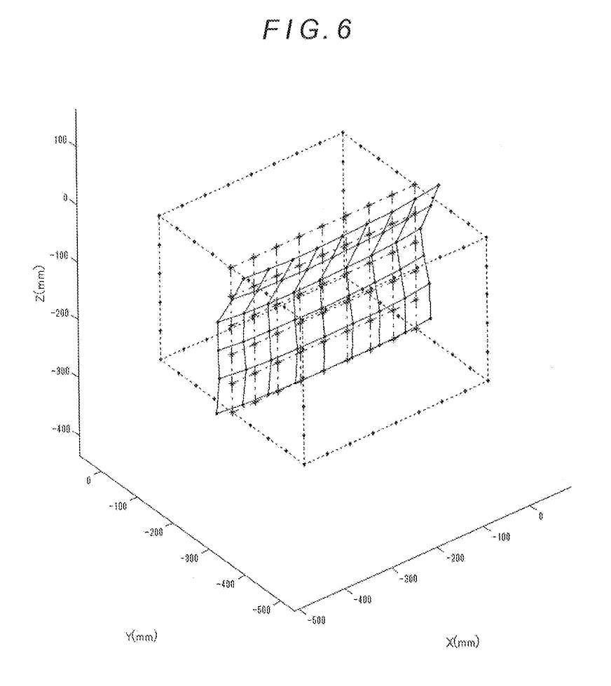

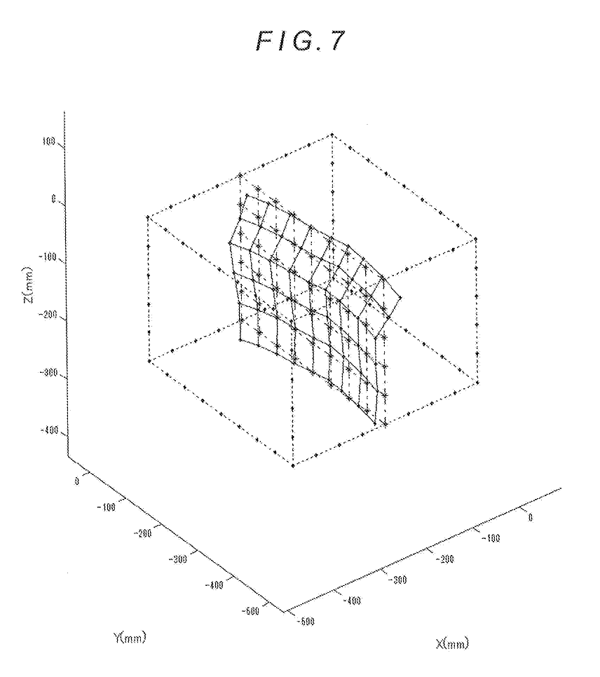

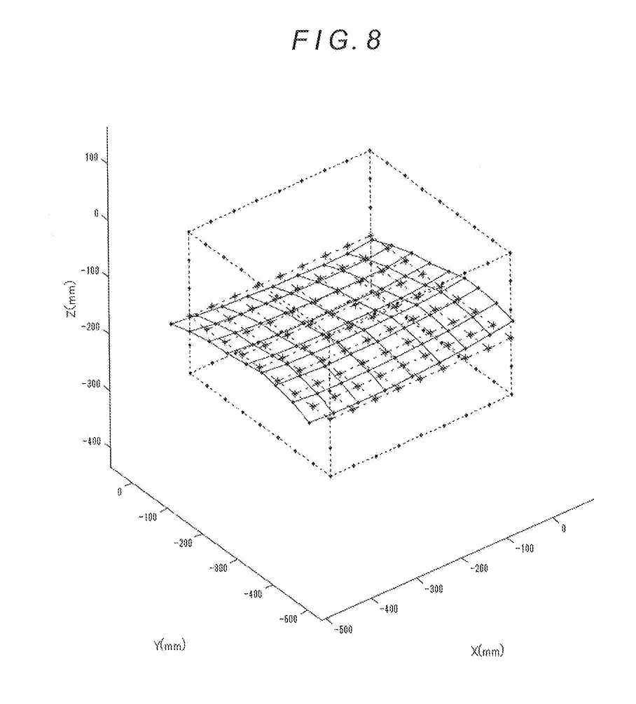

Examples of the position data (positioning errors, the same applies hereinafter) of the mirror 102 at the grid points that is obtained in the above-described manner are shown in FIGS. 6 to 8. FIG. 6 shows the position data at grid points in an X-Z plane, FIG. 7 shows the position data at grid points in a Y-Z plane, and FIG. 8 shows the position data at grid points in an X-Y plane. Further, the above errors obtained from these position data are shown in FIGS. 3 to 5. FIG. 3 shows the errors in the X-axis feed mechanism 55, FIG. 4 shows the errors in the Y-axis feed mechanism 56, and FIG. 5 shows the errors in the Z-axis feed mechanism 57. The error data storage 10 stores such error data therein.

The program analyzer 3 is a functional unit that reads out a machining program stored in the program storage 2 and executes the machining program. The program analyzer 3 recognizes operation commands contained in the machining program and transmits the recognized operation commands to the position commander 4. The operation commands contained in the machining program include at least commands relating to moving positions and feed speeds in the directions of the feed axes, i.e., the X-axis feed mechanism 55, the Y-axis feed mechanism 56, and the Z-axis feed mechanism 57.

The position commander 4 generates a position command with respect to a so-called machine coordinate system for each of the X-axis feed mechanism 55, Y-axis feed mechanism 56, and Z-axis feed mechanism 57 based on the operation commands for them that have been received from the program analyzer 3. In this process, based on a tool offset amount for a current tool to be used of the tool offset amounts stored in the tool offset storage 58, the position commander 4 generates position commands taking into account the tool offset amount, that is, position commands in which the commanded positions have been offset by the tool offset amount in the Z-axis direction. Note that the significance of this tool offset is described above based on FIG. 10.

Thereafter, the position commander 4 transmits the thus generated position command Ix (hereinafter, referred to also as “commanded position Ix”) for the X-axis feed mechanism 55 to the X-axis controller 11, the position command Iy (hereinafter, referred to also as “commanded position Iy”) for the Y-axis feed mechanism 56 to the Y-axis controller 12, and the position command Iz (hereinafter, referred to also as “commanded position Iz”) for the Z-axis feed mechanism 57 to the Z-axis controller 13, and also transmits the position commands Ix, Iy, Iz to the position compensator 5. Further, where the position commander 4 receives commands relating to a tool to be used from the program analyzer 3, the position commander 4 transmits the tool information to the position compensator 5.

As shown in FIG. 1, the position compensator 5 consists of a compensation amount calculator 6, a modification amount calculator 7, and a modified compensation amount calculator 8.

The compensation amount calculator 6 is a functional unit that calculates, by referring to the error data stored in the error data storage 10 based on the commanded position Ix for the X-axis feed mechanism 55, the commanded position Iy for the Y-axis feed mechanism 56, and the commanded position Iz for the Z-axis feed mechanism 57, which have been received from the position commander 4, compensation amounts Cx, Cy, Cz for the commanded positions Ix, Iy, Iz. Specifically, in a case where the commanded positions Ix, Iy, Iz correspond to each grid point, the compensation amount calculator 6 uses the error data for the grid point stored in the error data storage 10 to calculate the compensation amounts Cx, Cy, Cz for compensating for the errors in the X-axis, Y-axis, and Z-axis directions.

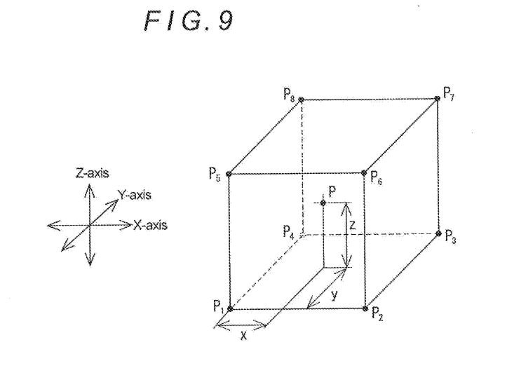

Further, in a case where a position P corresponding to the commanded positions Ix, Iy, Iz is located among grid points P₁ to P₈ as shown in FIG. 9, the compensation amount calculator 6 calculates the compensation amounts Cx, Cy, Cz in accordance with the following equations.

$$\begin{matrix}Cx = {Cx}_{1} \cdot ( 1 - x ) ( 1 - y ) ( 1 - z ) + {Cx}_{2} \cdot x ( 1 - y ) ( 1 - z ) + {Cx}_{3} \cdot xy ( 1 - z ) + {Cx}_{4} \cdot ( 1 - x ) y ( 1 - z ) + {Cx}_{5} \cdot ( 1 - x ) ( 1 - y ) z + {Cx}_{6} \cdot x ( 1 - y ) z + {Cx}_{7} \cdot xyz + {Cx}_{8} \cdot ( 1 - x ) yz & [ Equation 1 ] \\ Cy = {Cy}_{1} \cdot ( 1 - x ) ( 1 - y ) ( 1 - z ) + {Cy}_{2} \cdot x ( 1 - y ) ( 1 - z ) + {Cy}_{3} \cdot xy ( 1 - z ) + {Cy}_{4} \cdot ( 1 - x ) y ( 1 - z ) + {Cy}_{5} \cdot ( 1 - x ) ( 1 - y ) z + {Cy}_{6} \cdot x ( 1 - y ) z + {Cy}_{7} \cdot xyz + {Cy}_{8} \cdot ( 1 - x ) yz & [ Equation 2 ] \\ Cz = {Cz}_{1} \cdot ( 1 - x ) ( 1 - y ) ( 1 - z ) + {Cz}_{2} \cdot x ( 1 - y ) ( 1 - z ) + {Cz}_{3} \cdot xy ( 1 - z ) + {Cz}_{4} \cdot ( 1 - x ) y ( 1 - z ) + {Cz}_{5} \cdot ( 1 - x ) ( 1 - y ) z + {Cz}_{6} \cdot x ( 1 - y ) z + {Cz}_{7} \cdot xyz + {Cz}_{8} \cdot ( 1 - x ) yz & [ Equation 3 ]\end{matrix}$$

In these equations, x, y, z are internal ratios between grid points of the position P, and Cxₙ, Cyₙ, Czₙ are compensation amounts at a grid point Pₙ (n=1 to 8).

The modification amount calculator 7 is a functional unit that reads out, by referring to the tool offset storage 9 based on the tool information (information on the tool to be used) received from the position commander 4, the offset amount for the tool to be used, and calculates, based on the read-out offset amount and the error data stored in the error data storage 10, modification amounts Mx, My, Mz for the compensation amounts Cx, Cy, Cz calculated in the compensation amount calculator.

The modification amounts Mx, My, Mz modify errors which are caused by an orientational error of the spindle 54 and which occurs in accordance with a tool length of the tool to be used; they are calculated in accordance with the following equations:

Mx=−(Ecx+Ecy+Ecz)−Ly+(Ebx+Eby+Ebz)−Lz;

My=−(Eax+Eay+Eaz)−Lz+(Ecx+Ecy+Ecz)−Lx; and

Mz=−(Ebx+Eby+Ebz)−Lx+(Eax+Eay+Eaz)−Ly.

In these equations, Lx, Ly, Lz are deviations from a predetermined reference position on the axis of the spindle of a tip position of a tool attached to the spindle 54, Lx being a deviation in the X-axis direction, Ly being a deviation in the Y-axis direction, and Lz being a deviation in the Z-axis direction. The tool tip position corresponds to Tt shown in FIGS. 10 and 11. Further, as described above, the reference position is a position of the mirror 102 and corresponds to the position R shown in FIGS. 10 and 11.

By the way, as seen from FIG. 11, in a case where the tool tip position Tt is displaced by a deviation Lz in the Z-axis direction from the reference position R, when a positional error of the tool tip position Tt caused by an orientational error of the spindle 54 is viewed in a plane defined by the X-axis and the Z-axis, it is large in the X-axis direction but is small in the Z-axis direction. Similarly, when viewed in a plane defined by the X-axis and the Y-axis, it is large in the Y-axis direction but is small in the Z-axis direction. Therefore, a displacement in the Z-axis direction (deviation Lz) of the tool tip position Tt is considered to cause a positional error mainly in the X-axis direction and the Y-axis direction. Similarly, a displacement in the X-axis direction (deviation Lx) of the tool tip position Tt is considered to cause a positional error mainly in the Y-axis direction and the Z-axis direction, and a displacement in the Y-axis direction (deviation Ly) of the tool tip position Tt is considered to cause a positional error mainly in the X-axis direction and the Z-axis direction.

Accordingly, the positional error in the X-axis direction is regarded as an error that varies in accordance with the deviations Ly and Lz caused by an orientational error of the spindle 54, and the modification amount Mx for compensating for such a positional error is calculated by a compensation term for Ly and a compensation term for Lz, as indicated in the above equation. Similarly, the positional error in the Y-axis direction is regarded as an error that varies in accordance with the deviations Lx and Lz caused by an orientational error of the spindle 54, and the modification amount My for compensating for such a positional error is calculated by a compensation term for Lx and a compensation term for Lz, as indicated in the above equation. Further, the positional error in the Z-axis direction is regarded as an error that varies in accordance with the deviations Lx and Ly caused by an orientational error of the spindle 54, and the modification amount Mz for compensating for such a positional error is calculated by a compensation term for Lx and a compensation term for Ly, as indicated in the above equation.

Note that the above equations are modification amount calculating equations for the case where the tool tip position Tt is displaced in the X-axis, Y-axis, and Z-axis directions from the reference position R. A configuration of the machine tool 50 which causes such displacement of the tool tip position Tt in the X-axis, Y-axis, and Z-axis directions from the reference position R is, for example, a configuration in which the spindle 54 is configured to be turned. In contrast, in the above equations, in a case where the tool tip position is located on the axis of the spindle, such as a configuration in which the spindle 54 is not configured to be turned, Lx=Ly=0 holds. Therefore, in this case, modification using only Mx and My taking into account only Lz is carried out.

Further, in the case where the position commands Ix, Iy, Iz correspond to each grid point, the error data for the grid point stored in the error data storage 10 is applied to Eax, Ebx, Ecx, Eay, Eby, Ecy, Eaz, Ebz, Ecz. In the case where the position P corresponding to the position commands Ix, Iy, Iz is located among grid points P₁ to P₈ as shown in FIG. 9, Eax, Ebx, Ecx, Eay, Eby, Ecy, Eaz, Ebz, Ecz are calculated in accordance with the following equations.

Eix=Eix₁−(1−x)+Eix₂−x

Eiy=Eiy₁−(1−y)+Eiy₄·y

Eiz=Eiz₁−(1−z)+Eiz₅·z

In these equations, i=a, b, c. Further, x, y, z are internal ratios between grid points of the position P, and Eixₙ, Eiyₙ, and Eizₙ are each an amount of error at the grid point Pₙ (n=1 to 8).

Note that, in each of the above equations for calculating Mx, My, and Mz, whether the first term is positive or negative and whether the second term is positive or negative are each determined in accordance with the positive/negative directions of the X-axis, Y-axis, and Z-axis.

The modified compensation amount calculator 8 is a functional unit that calculates modified compensation amounts Cx′, Cy′, Cz′ for the position commands Ix, Iy, Iz based on the compensation amounts Cx, Cy, Cz for the position commands Ix, Iy, Iz calculated by the compensation amount calculator 6 and the modification amounts Mx, My, Mz for the position commands Ix, Iy, Iz calculated by the modification amount calculator 7, and adds the calculated modified compensation amounts Cx′, Cy′, Cz′ to the position commands Ix, Iy, Iz to be transmitted from the position commander 4 to the X-axis controller 11, the Y-axis controller 12, and the Z-axis. Specifically, the modified compensation amount calculator 8 adds the modified compensation amount Cx′ to the position command Ix, the modified compensation amount Cy′ to the position command Iy, and the modified compensation amount Cz′ to the position command Iz.

Note that the modified compensation amounts Cx′, Cy′, Cz′ are calculated in accordance with the following equations:

Cx′=Cx+Mx;

Cy′=Cy+My; and

Cz′=Cz+Mz.

The X-axis controller 11 feedback-controls the X-axis servo motor 55a of the X-axis feed mechanism 55 in accordance with the position command (Ix+Cx′) transmitted from the position commander 4 and compensated for by the position compensator 5. Similarly, the Y-axis controller 12 feedback-controls the Y-axis servo motor 56a of the Y-axis feed mechanism 56 in accordance with the position command (Iy+Cy′) transmitted from the position commander 4 and compensated for by the position compensator 5. Furthermore, the Z-axis controller 13 also similarly feedback-controls the Z-axis servo motor 57a of the Z-axis feed mechanism 57 in accordance with the position command (Iz+Cz′) transmitted from the position commander 4 and compensated for by the position compensator 5.

In the numerical control device 1 according to this embodiment having the above-described configuration, a processing is started by an execution signal for starting a machining program stored in the program storage 2 being externally input.

That is, when the execution signal is externally input, first, the program analyzer 3 reads out a corresponding machining program from the machining program storage 2 and analyzes the machining program in sequence, thereby successively recognizing operation commands contained in the machining program. The recognized operation commands are successively transmitted to the position commander 4.

In a case where the transmitted operation commands are moving positions and feed speeds for the X-axis feed mechanism 55, the Y-axis feed mechanism 56, and the Z-axis feed mechanism 57, the position commander 4 successively generates position commands Ix, Iy, Iz with respect to a so-called machine coordinate system for them, and transmits the position command Ix to the X-axis controller 11, the position command Iy to the Y-axis controller 12, and the position command Iz to the Z-axis controller 13. In this process, the position commander 4 reads out a tool offset amount for a current tool to be used from the tool offset storage 58 and generates the position commands Ix, Iy, Iz taking into account this tool offset amount.

On the other hand, in the position compensator 5, the compensation amount calculator 6 calculates compensation amounts Cx, Cy, Cz for the position commands Ix, Iy, Iz by referring to the error data stored in the error data storage 10 based on the position commands Ix, Iy, Iz received from the position commander 4.

Further, the modification amount calculator 7 reads out, by referring to the tool offset storage 9 based on the tool information (information on the tool to be used) received from the position commander 4, an offset amount for the tool to be used, and calculates, based on the read-out offset amount and the error data stored in the error data storage 10, modification amounts Mx, My, Mz for the compensation amounts Cx, Cy, Cx calculated in the compensation amount calculator 6.

Further, the modified compensation amount calculator 8 calculates modified compensation amounts Cx′, Cy′, Cz′ for the position commands Ix, Iy, Iz based on the compensation amounts Cx, Cy, Cz calculated in the compensation amount calculator 6 and the modification amounts Mx, My, Mz calculated in the modification amount calculator 7, and adds the modified compensation amount Cx′ to the position command Ix, the modified compensation amount Cy′ to the position command Iy, and the modified compensation amount Cz′ to the position command Iz, whereby the position commands Ix, Iy, Iz are compensated for.

Accordingly, the X-axis controller 11 feedback-controls the X-axis servo motor 55a in accordance with the compensated position command (Ix+Cx′), the Y-axis controller 12 feedback-controls the Y-axis servo motor 56a in accordance with the compensated position command (Iy+Cy′), and the Z-axis controller 13 feedback-controls the Z-axis servo motor 57a in accordance with the compensated position command (Iz+Cz′).

Thus, in the numerical control device 1 according to this embodiment, based on commanded positions Ix, Iy, Iz for the X-axis feed mechanism 55, the Y-axis feed mechanism 56, and the Z-axis feed mechanism 57 and the error data stored in the error data storage 10, the position compensator 5 calculates compensation amounts Cx, Cy, Cz for the commanded positions Ix, Iy, Iz, and uses the calculated compensation amounts Cx, Cy, Cz to compensate for the corresponding commanded positions Ix, Iy, Iz. This compensation compensates for motion errors in three-dimensional space of the machine tool 50 with high accuracy.

Further, the position compensator 5 calculates, based on the commanded positions Ix, Iy, Iz, the error data stored in the error data storage 10, and a tool offset amount for a tool length of a tool to be used for machining, modification amounts Mx, My, Mz, which vary in accordance with the tool length, for the compensation amounts Cx, Cy, Cz, and modifies the compensation amounts Cx, Cy, Cz with the calculated modification amounts Mx, My, Mz. Therefore, it is possible to compensate for a positional error of a tool tip position that occurs in accordance with an orientational error of the spindle 54 and the tool length, and therefore it is possible to control positioning of the tool tip position in three-dimensional space with higher accuracy than the conventional art.

Hereinbefore, one embodiment of the present invention has been described. However, the present invention is not limited thereto and can be implemented in other modes.

For example, the compensation amount calculator 6 in the above embodiment calculates errors of a commanded position (x, y, z) by using an interpolation process based on positioning errors at grid points of a motion area divided in a grid-like pattern with a certain interval, and calculates compensation amounts for compensating for the calculated errors. However, the present invention is not limited thereto, and a kinematic model may be used to predict errors from the kinematic model in accordance with commanded positions (x, y, z).

Further, the error data stored in the error data storage 10 is not limited to the above-described error data per se, and may be data containing such error components in a manner such that they can be extracted (for example, vector data).

Furthermore, although the above embodiment is configured to calculate the compensation amounts Cx, Cy, Cz in the position compensator 5, more specifically, in the compensation amount calculator 6, the present invention is not limited thereto and a configuration is possible in which the compensation amounts Cx, Cy, Cz are previously calculated and stored in an appropriate storage, such as the error data storage 10. In this configuration, the compensation amount calculator 6 is not particularly necessary, and, for example, the modified compensation amount calculator 8 may be configured to read out the compensation amounts Cx, Cy, Cz corresponding to the commanded positions Ix, Iy, Iz from the storage and modify the read-out compensation amounts Cx, Cy, Cz with the modification amounts Mx, My, Mz calculated by the modification amount calculator 7.

### REFERENCE SIGNS LIST

1 Numerical control device
2 Program storage
3 Program analyzer
4 Position commander
5 Position compensator
6 Compensation amount calculator
7 Modification amount calculator
8 Modified compensation amount calculator
9 Tool offset storage
10 Error data storage
11 X-axis controller
12 Y-axis controller
13 Z-axis controller
55 X-axis feed mechanism
55a X-axis servo motor
56 Y-axis feed mechanism
56a Y-axis servo motor
57 Z-axis feed mechanism
57a Z-axis servo motor

1. A numerical control device for, in a machine tool including a spindle holding a tool, and feed axes corresponding to reference axes: a Z-axis extending along an axis of the spindle, and an X-axis and a Y-axis orthogonal to the Z-axis and orthogonal to each other, numerically controlling the feed axes, the numerical control device comprising:
an error data storage storing therein error data including components regarding angular errors Eax, Eay, Eaz around the X-axis in the feed axes, angular errors Ebx, Eby, Ebz around the Y-axis in the feed axes, and angular errors Ecx, Ecy, Ecz around the Z-axis in the feed axes; and
a position compensator compensating for commanded positions Ix, Iy, Iz for the feed axes with compensation amounts Cx, Cy, Cz corresponding to the commanded positions Ix, Iy, Iz, wherein
the position compensator is further configured to calculate modification amounts Mx, My, Mz for the compensation amounts Cx, Cy, Cz for the feed axes in accordance with equations below, the commanded positions Ix, Iy, Iz for the feed axes, the error data stored in the error data storage, and data on a tool length of a tool to be used for machining, and modify the compensation amounts Cx, Cy, Cz with the calculated modification amounts Mx, My, Mz, the modification amounts Mx, My, Mz varying in accordance with the tool length:
Mx=−(Ecx+Ecy+Ecz)−Ly+(Ebx+Eby+Ebz)−Lz;
My=−(Eax+Eay+Eaz)−Lz+(Ecx+Ecy+Ecz)−Lx; and
Mz=−(Ebx+Eby+Ebz)−Lx+(Eax+Eay+Eaz)−Ly,
where Lx, Ly, and Lz are deviations from a predetermined reference position of a tip position of a tool attached to the spindle of the machine tool, Lx being a deviation in a direction of the X-axis, Ly being a deviation in a direction of the Y-axis, and Lz being a deviation in a direction of the Z-axis.

2. The numerical control device according to claim 1, wherein:
the numerical control device further comprises a tool length data storage storing therein data varying in accordance with the tool length of the tool to be used for machining; and
the tool compensator is configured to calculate the modification amounts Mx, My, Mz based on the data stored in the tool length data storage.

3. The numerical control device according to claim 2, wherein the tool length data storage is configured to store therein a tool offset amount for offsetting the commanded positions Ix, Iy, Iz in accordance with the tool length.
